(19) United States
(12) Patent Application Publication
(10) Pub. No.: US 2019/0265398 A1
(43) Pub. Date: Aug. 29, 2019

(54) DISPLAY PANEL AND DISPLAY APPARATUS

(71) Applicants: HKC Corporation Limited, Shenzhen (CN); Chongqing HKC Optoelectronics Technology Co., Ltd., Chongqing (CN)

(72) Inventor: Yu-Jen CHEN, Chongqing (CN)

(21) Appl. No.: 16/411,148

(22) Filed: May 14, 2019

Related U.S. Application Data
(63) Continuation-in-part of application No. PCT/CN2017/081609, filed on Apr. 24, 2017.

(30) Foreign Application Priority Data
Apr. 21, 2017 (CN) 2017102652249

(51) Int. Cl. G02B 5/20; G02F 1/1362

(52) U.S. Cl. CPC G02B 5/201; G02F 2001/136222; G02F 1/1362

(57) ABSTRACT

The present application discloses a display panel and a display apparatus. The display panel includes a first underlay substrate, a color filter layer, and a conducting layer. The color filter layer is made of chemically resistive material, and the color filter layer includes a first surface and a second surface opposite to the first surface, the color filter layer is disposed on the first underlay substrate, and the first surface of the color filter layer is disposed towards to the first underlay substrate. The conducting layer is disposed on the color filter layer, and the second surface of the color filter layer is disposed towards to the conducting layer.

The present application is a continuation-in-part of application No. PCT/CN2017/081609 filed on Apr. 24, 2017, which claim the benefit of Chinese Patent Application No. CN2017102652249 filed on Apr. 21, 2017, and entitled “DISPLAY PANEL AND DISPLAY APPARATUS”. The entire contents of the above applications are hereby incorporated by reference in their entirety.

### TECHNICAL FIELD

This application relates to the technical field of displays, and more particularly to a display panel and a display apparatus.

### BACKGROUND

The description herein provides only background information related to this application, but does not necessarily constitute the existing technology.

Liquid crystal display apparatuses have numerous advantages, such as a thin body, power savings, no radiation, etc., and are widely used. Most liquid crystal display apparatuses are backlight type liquid crystal display apparatuses, each including a liquid crystal panel and a backlight module. Working principle of the liquid crystal panel is that liquid crystals are disposed between two parallel glass substrates, and a driving voltage is applied to the two glass substrates to control rotation direction of the liquid crystals, to refract light rays of the backlight module to generate a picture.

Thin film transistor-liquid crystal display (TFT-LCD) apparatuses maintain a leading status in the display field because of low power consumption, excellent picture quality, high production yield, and other properties. Similarly, the TFT-LCD apparatuses include a liquid crystal panel and a backlight module. The liquid crystal panel includes a color filter substrate (CF substrate) and a thin film transistor substrate (TFT substrate), and transparent electrodes on respective inner sides of the above substrates. A layer of liquid crystal (LC) is disposed between two substrates. The liquid crystal panel changes the polarized state of light by controlling direction of the LCs through an electric field, for penetration and obstruction of a light path via a polarized plate to display.

In the process of manufacturing a color filter substrate, a color filter layer is formed by repeated photoresist coating, exposure and developing, and then a CF (color filter) substrate finished product is formed by using technologies, such as indium tin oxides (ITO), photo spacer (PS), etc. In the technological process of the color filter layer, first, an inorganic insulating film needs to be laid. Then, the color filter layer is laid on the inorganic insulating film. For example, R/G/B photoresist is laid on the inorganic insulating film. Finally, an inorganic insulating film or an organic insulating film is laid on the color filter layer. Such liquid crystal panel has a complex structure. The technological process of the color filter layer is complex, and production efficiency is reduced.

### SUMMARY

The present application provides a display panel with simple structure so that a technological process of a color filter layer is simple, to increase production efficiency.

Furthermore, the present application provides a display apparatus including the above display panel.

The aim of the present application is achieved through the following methods.

According to one aspect of the present application, the present application discloses a display panel including:

a first underlay substrate;

a color filter layer, made of a chemically resistive material, and the color filter layer includes a first surface and a second surface opposite to the first surface, the color filter layer is disposed on the first underlay substrate, and the first surface of the color filter layer is disposed towards to the first underlay substrate;

a conducting layer, disposed on the color filter layer; and

a plurality of active switches, disposed on the first underlay substrate;

the first surface of the color filter layer is in contact with the first underlay substrate, and the second surface of the color filter layer is in contact with the conducting layer; the active switch includes a gate, a semiconductor, a source and a drain disposed in sequence; the source and the drain are in contact with the first surface of the color filter; and the color filter is doped with inorganic material.

The active switch includes a gate, a semiconductor, a source and a drain disposed in sequence, and the source and the drain are in contact with the first surface.

The present application discloses a display panel including:

a first underlay substrate;

a color filter layer, made of chemically resistive material, the color filter layer includes a first surface and a second surface opposite to the first surface, the color filter layer is disposed on the first underlay substrate, and the first surface of the color filter layer is disposed towards to the first underlay substrate, and

a conducting layer, disposed on the color filter layer, and the second surface of the color filter layer is disposed towards to the conducting layer.

Optionally; the first surface of the color filter layer is in contact with the first underlay substrate, and the second surface of the color filter layer is in contact with the conducting layer. This is a specific structure of the display panel in this application. In this application, the first surface of the color filter layer is directly in contact with the first underlay substrate, and the second surface of the color filter layer is directly in contact with the conducting layer. Compared with the prior art, the inorganic insulating film or the organic insulating film laid on both surfaces of the color filter layer can be completely omitted. The display panel in the present application is simple in structure and convenient in manufacture, and increases the production efficiency.

Optionally, the first surface of the color filter layer is disposed on a first chemically resistive layer, and the first chemically resistive layer is disposed between the first surface of the color filter layer and the first underlay substrate. This is another specific structure of the display panel in present application. In this application, the first chemically resistive layer is only disposed between the first surface of the color filter layer and the first underlay substrate. Compared with the inorganic insulating film or the organic insulating film laid on both surfaces of the color filter layer, the display panel in present application not only has simple structure, but also further enhances the chemical resistance characteristic of the color filter layer.

Optionally, the first chemically resistive layer is made of an inorganic insulating film. The inorganic insulating film has good chemical resistance and includes but not limited to non-alkali glass fiber cloth, glass fiber mat, glass fiber paper, asbestos paper, asbestos cloth, asbestos felt, cellulose paper, cotton cloth, mica products, ceramics, marble and glass.

Optionally, a plurality of active switches are disposed on the first underlay substrate, the active switch includes a gate, a semiconductor, a source and a drain disposed in sequence; one side of the first chemically resistive layer is in contact with the first surface of the color filter, and the other side of the first chemically resistive layer is in contact with the source and the drain.

Optionally, the second surface of the color filter layer is disposed on a second chemically resistive layer and the second chemically resistive layer is disposed between the second surface of the color filter and the conducting layer. This is another specific stricture of the display panel in present application. In the present application, the second chemically resistive layer is only disposed between the second surface of the color filter layer and the conducting layer. Compared with the inorganic insulating film or the organic insulating film laid on both surfaces of the color filter layer, the display panel in present application not only has simple structure, but also further enhances the chemical resistance characteristic of the color filter layer.

Optionally, the second chemically resistive layer is made of an inorganic insulating film. The inorganic insulating film has good chemical resistance and includes but not limited to non-alkali glass fiber cloth, glass fiber mat, glass fiber paper, asbestos paper, asbestos cloth, asbestos felt, cellulose paper, cotton cloth, mica products, ceramics, marble and glass.

Optionally; the second chemically resistive layer is made of an organic insulating film. The organic insulating film includes but not limited to lac, resin, rubber, cotton yarn, paper, hemp, natural silk and artificial silk.

Optionally, the first underlay substrate is disposed on an array substrate or disposed on a color filter substrate.

Optionally, a plurality of active switches are disposed on the first underlay substrate, and the active switch includes a gate, a semiconductor, a source and a drain disposed in sequence: one side of the first chemically resistive layer is in contact with the first surface of the color filter, and the other side of the first chemically resistive layer is in contact with the source and the drain.

Optionally, the color filter layer is made of chemically resistive material, the chemically resistive material includes inorganic material.

Optionally, the display panel includes a first chemically, a plurality of active switches and a second chemically resistive layer, the first chemically resistive layer is disposed between the first surface of the color filter and the first underlay substrate, and the first chemically resistive layer is made of an inorganic insulating film, the active switches are disposed on the first underlay substrate; the second chemically resistive layer, disposed on the second surface of the color filter layer, the second chemically resistive layer is disposed between the second surface of the color filter and the conducting layer, the second chemically resistive layer is made of an inorganic insulating film or an organic insulating film; and the conducting layer is made of indium tin oxides.

According to another aspect of the present application, the present application further discloses a display apparatus which includes the above display panel.

The color filter layer of the display panel in the present application is directly made of the chemically resistive material to increase the chemical resistance characteristic of the color filter layer.

### BRIEF DESCRIPTION OF DRAWINGS

The drawings included are used for providing further understanding of embodiments of the present application, constitute part of the description, are used for illustrating implementation manners of the present application, and interpreting principles of the present application together with text description. Apparently, the drawings in the following description are merely some embodiments of the present application, and for those of ordinary skill in the art, other drawings can also be obtained according to the drawings without contributing creative labor. In the drawings:

FIG. 1 is a structural schematic diagram of a display panel in the present application.

FIG. 2 is a structural schematic diagram of a display panel in an embodiment of the present application.

FIG. 3 is a structural schematic diagram of a display panel in an embodiment of the present application.

FIG. 4 is a structural schematic diagram of a display panel in an embodiment of the present application.

FIG. 5 is a schematic diagram of a display apparatus in an embodiment of the present application.

### DETAILED DESCRIPTION

Specific structure and function details disclosed herein are only representative and are used for the purpose of describing exemplary embodiments of the present application. However, the present application may be specifically achieved in many alternative forms and shall not be interpreted to be only limited to the embodiments described herein.

It should be understood in the description of the present application that terms such as “central” “horizontal”, “upper”, “lower”, “left”, “right”, “vertical”, “horizontal”, “top”, “bottom”, “inner”, “outer”, etc. indicate direction or position relationships shown based on the drawings, and are only intended to facilitate the description of the present application and the simplification of the description rather than to indicate or imply that the indicated, apparatus or element must have a specific direction or constructed and operated in a specific direction, and therefore, shall not be understood as a limitation to the present application. In addition, the terms such as “first” and “second” are only used for the purpose of description, rather than being understood to indicate or imply relative importance or hint the number of indicated technical features. Thus, the feature limited by “first” and “second” can explicitly or impliedly comprise one or more features. In the description of the present application, the meaning of “a plurality of” is two or more unless otherwise specified. In addition, the term “comprise” and any variant are intended to cover non-exclusive inclusion.

It should be noted in the description of the present application that, unless otherwise specifically regulated and defined, terms such as “installation”, “contact” and “bonding” shall be understood in broad sense, and for example, may refer to fixed bonding or detachable bonding or integral bonding, may refer to mechanical bonding or electrical bonding, and may refer to direct bonding or indirect bonding through an intermediate medium or inner communication of two elements. For those of ordinary skill in the art, the meanings of the above terms in the present application be understood according to concrete conditions.

The terms used herein are intended to merely describe concrete embodiments, not to limit the exemplary embodiments. Unless otherwise noted clearly in the context, singular forms “one” and “single” used herein are also intended to comprise plurals. It should also be understood that the terms “comprise” and/or “include” used herein specify the existence of stated features, integers, steps, operation, units and/or assemblies, not excluding the existence or addition of one or more other features, integers, steps, operation, units, assemblies and/or combinations of these.

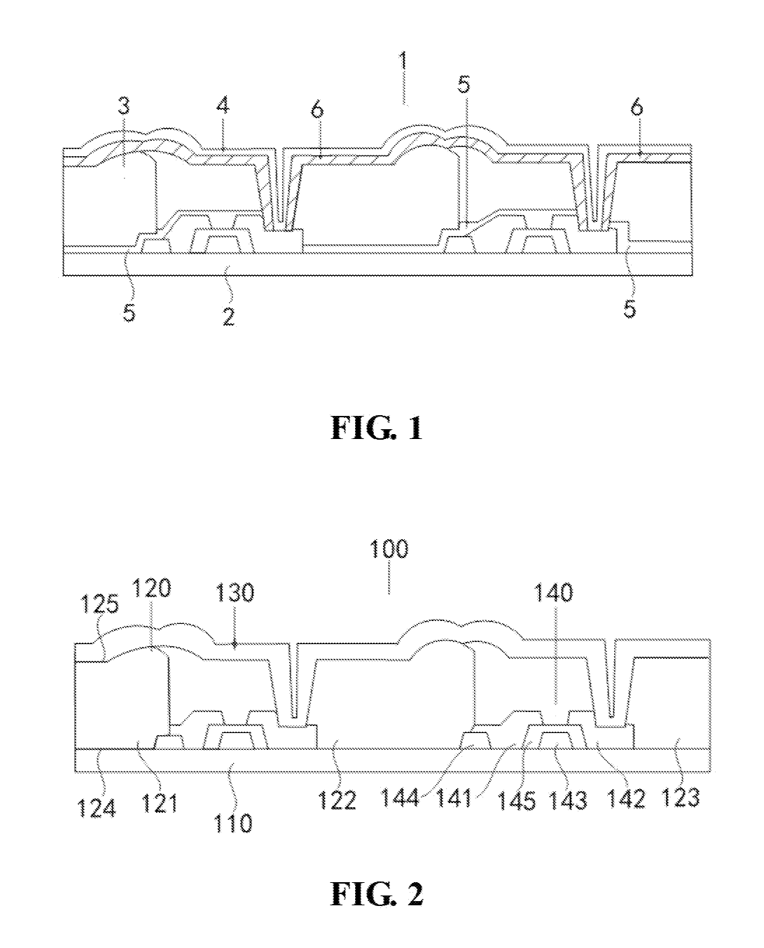

The display panel and the display apparatus of the present application are described below with reference to FIG. 1 to FIG. 5.

As shown in FIG. 1, FIG. 1 is a structure of a display panel designed by the applicant. Specifically, the display panel 1 includes an underlay substrate 2, a color filter layer 3, indium tin oxides (ITO) 4, a first inorganic insulating film 5, and a second inorganic insulating film 6. However, the display panel has a complex structure. In a production technology of the display panel, process flows are complex and production efficiency is reduced.

Therefore, the applicant also designs another technical solution.

Specifically, the present application will be further described in detail below in combination with FIG. 2 to FIG. 5 and optional embodiments.

According to an embodiment of the present application, as shown in FIG. 2 to FIG. 4, an embodiment of the present application discloses a display panel 100 which includes a first underlay substrate 110, a color filter layer 120, a conducting layer 130, and an active switch 140. the color filter layer 120 is made of chemically resistive material, the color filter layer 120 includes a first surface 124 and a second surface 125 opposite to the first surface, the color filter layer 120 is disposed on the first underlay substrate 110, and the first surface 124 of the color filter layer 120 is disposed towards to the first underlay substrate 110, the conducting layer 130 is disposed on the color filter layer, the active switches 140 are disposed on the first underlay substrate, the first surface of the color filter layer is in contact with the first underlay substrate, and the second surface of the color filter layer is in contact with the conducting layer; the active switch includes a gate 143, a semiconductor 145, a source 141 and a drain 142 disposed in sequence; the source 141 and the drain 142 are in contact with the first surface of the color filter 120, and the color filter 120 is doped with inorganic material.

This application discloses a display panel 100 which includes a first underlay substrate 110, a color filter layer 120, and a conducting layer 130, the color filter layer 120 is made of chemically resistive material, the color filter layer 120 includes a first surface 124 and a second surface 125 opposite to the first surface 124, the color filter layer 120 is disposed on the first underlay substrate 110, and the first surface 124 of the color filter layer 120 is disposed towards to the first underlay substrate 110, the conducting layer 130 is disposed on the color filter layer 120, and the second surface 125 of the color filter layer 120 is disposed towards to the conducting layer 130.

The color filter layer of the display panel 100 in the present application is directly made of the chemically resistive material to increase the chemical resistance characteristic of the color filter layer, ensure the display panel display effect, and improve the service life of the color filter layer.

An exemplary display panel has a complex structure. Especially, an inorganic insulating film or an organic, insulating film needs to be laid on both surfaces of the structure of the color filter layer, causing the complex production process of the color filter layer and production efficiency is reduced. In this application, the color filter layer is made of chemically resistive material is disposed on active switches, so that the inorganic insulating film or the organic insulating film on both surfaces of the color filter layer can be omitted. Thus, a structure of the display panel is simplified. In the manufacturing process of the display panel, the process of laying two layers of the inorganic insulating films or the organic insulating films is omitted, thereby simplifying the manufacturing process of the display panel and increasing the production efficiency.

In one or more embodiment, the display panel in the embodiment of the present application may include any of the following: a twisted nematic (TN) or super twisted nematic (STN) type panel, an in-plane switching (IPS) type panel, a vertical alignment (VA) type panel, a high vertical alignment (HVA) type panel and a curved surface type panel. However, it should be explained that the display panel in the present embodiment is riot limited thereto.

In one or more embodiments, the first underlay substrate 110 in the embodiment of the present application may be a glass plate which has good transmissivity and is conveniently arranged. Of course, it should be explained that the first underlay substrate in the present embodiment is not limited thereto. For example, the first underlay substrate may be a flexible substrate. In addition, it should be explained that the first underlay substrate in the present embodiment of the present application can be disposed on the array substrate or disposed on the color filter substrate.

In one or more embodiments, the color filter layer 120 in the embodiment of the present application includes but not limited to a red photoresist 121, a green photoresist 122, and a blue photoresist 123. It should be explained that the color photoresist 111 in the present embodiment is not limited to the red photoresist 121, the green photoresist 122, and the blue photoresist 123, and can also include other color photoresists, such as a white photoresist and a yellow photoresist.

In one or more embodiments, the color filter layer 120 in the embodiment of the present application is made of chemically resistive material. The chemically resistive material may be specifically inorganic material and includes but not limited to non-alkali glass fiber cloth, glass fiber mat, glass fiber paper, asbestos paper, asbestos cloth, asbestos felt, cellulose paper, cotton cloth, mica products, ceramics, marble, and glass. It should be explained that the chemically resistive material in the embodiment of the present application is not limited thereto. Specifically, in manufacturing the color filter layer in the embodiment of the present application, a color photoresist in the prior art can be adopted, and the chemically resistive material is doped in the color photoresist in the prior art. Specifically, the inorganic material is doped. Thus, the chemical resistance of the color filter layer can be increased.

In one or more embodiments, the color filter layer 120 includes a first surface 124 and a second surface 125 opposite to the first surface 124, the color filter layer 120 is disposed on the first underlay substrate 110 and the first surface 124 of the color filter layer 120 is adjacent to the first underlay substrate 110. The conducting layer 130 is disposed on the color filter layer 120, and the second surface 125 of the color filter layer 120 is adjacent to the conducting layer 130. The color filter layer 120 of the display panel 100 in the embodiment of the present application is directly made of the chemically resistive material to increase chemical resistance characteristic of the color filter layer so that the inorganic insulating film or the organic insulating film on both surfaces of the color filter layer 120 can be omitted. Thus, structure of the display panel 100 is simplified. In manufacturing the display panel 100, the process of laying two inorganic insulating films or the organic insulating films is omitted, thereby saving the manufacturing processes of the display panel and increasing production efficiency.

In a better choice of an embodiment of the present application, as shown in FIG. 2, the first surface 124 of the color filter layer 120 is in contact with the first underlay substrate 110, and the second surface 125 of the color filter layer 120 is in contact with the conducting layer 130. This is a specific structure of the display panel 100 in the embodiment of the present application. In the embodiment of the present application, the first surface 124 of the color filter layer 120 is directly in contact with the first underlay substrate 110, and the second surface 125 of the color filter layer 120 is directly in contact with the conducting layer 130 so that the inorganic insulating film or the organic insulating film laid on both surfaces of the color filter layer can be completely omitted. The display panel 100 in the embodiment of the present application is simple in structure and convenient in manufacture, and increases production efficiency.

It should be explained that the structure of the display panel in the embodiment of the present application is not limited thereto. The display panel can also be arranged into other structures, specifically:

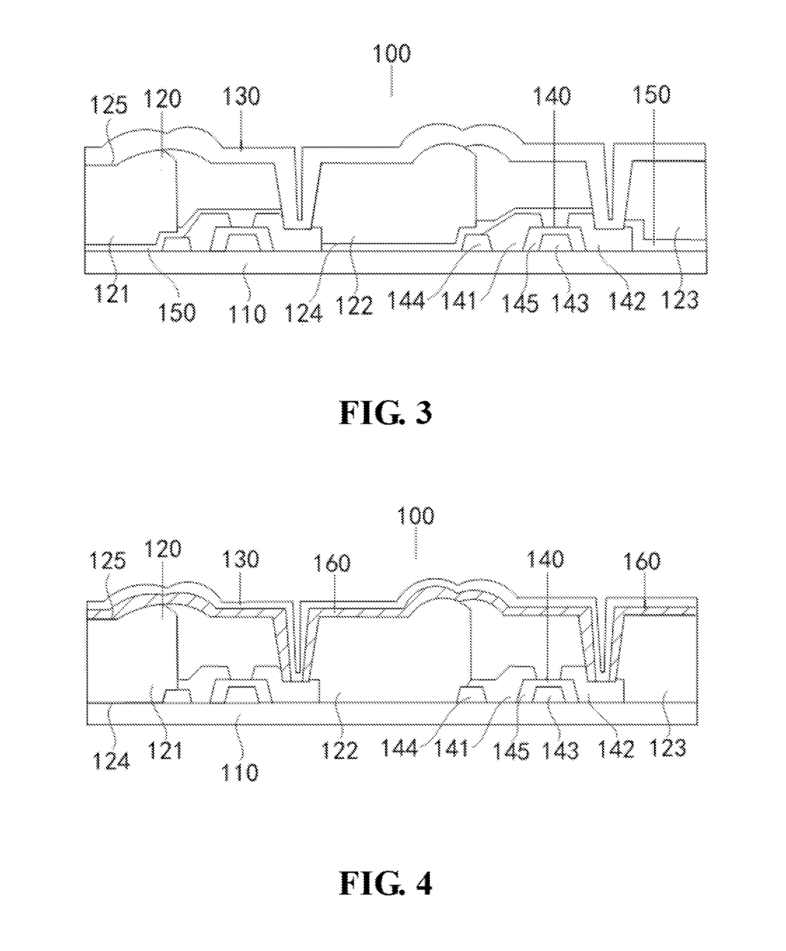

Example 1: As shown in FIG. 3, the first surface 124 of the color filter layer 120 is disposed on a first chemically resistive layer 150, and the first chemically resistive layer 150 is disposed between the first surface 124 and the first underlay substrate 110. This is another specific structure of the display panel 100 in the embodiment of the present application. In the embodiment of the present application, the first chemically resistive layer 150 is only disposed between the first surface 124 of the color filter layer 120 and the first underlay substrate 110. Compared with the inorganic insulating film or the organic insulating film laid on both surfaces of the color filter layer, the display panel 100 in the embodiment of the present application not only has a simple structure, but also further enhances chemical resistance characteristic of the color filter layer 120.

In one or more embodiments, the display panel includes a plurality of active switches 140, the active switches 140 are disposed on the first underlay substrate 110, and the active switch includes a gate 143, a semiconductor 145, a source 141 and a drain 142 disposed in sequence; one side of the first chemically resistive 150 layer is in contact with the first surface of the color filter, and the other side of the first chemically resistive layer is in contact with the source 141 and the drain 142

In one or more embodiments, the first chemically resistive layer 150 is made of the inorganic insulating film. The inorganic insulating film has good chemical resistance and includes but not limited to non-alkali glass fiber cloth, glass fiber mat, glass fiber paper, asbestos paper, asbestos cloth, asbestos felt, cellulose paper, cotton cloth, mica products, ceramics, marble, and glass.

Example 2: As shown in FIG. 4, the second surface 125 of the color filter layer 120 is disposed on a second chemically resistive layer 160 and the second chemically resistive layer 160 is disposed between the second surface 125 and the conducting layer 130. This is another specific structure of the display panel 100 in the embodiment of the present application. In the embodiment of the present application, the second chemically resistive layer 160 is only disposed between the second surface 125 of the color filter layer 120 and the conducting layer 130. Compared with the inorganic insulating film or the organic insulating film laid on both surfaces of the color filter layer, the display panel 100 in the embodiment of the present application not only has simple structure, but also further enhances chemically resistive characteristics of the color filter layer.

In one or more embodiments, the second chemically resistive layer 160 is made of the inorganic insulating film. The inorganic insulating film has good chemical resistance and includes but not limited to non-alkali glass fiber cloth, glass fiber mat, glass fiber paper, asbestos paper, asbestos cloth, asbestos felt, cellulose paper, cotton cloth, mica products, ceramics, marble, and glass. It should be explained that the second chemically resistive layer in the embodiment of the present application can also be made of other materials. For example, the second chemically resistive layer is made of the organic insulating film, and the organic insulating film includes but not limited to lac, resin, rubber, cotton yarn, paper, hemp, natural silk, and artificial silk.

The active switch 140 includes a source 141, a drain 142, a gate 143, a data line 144 and a semiconductor 145, the semiconductor 145 is covered on the gate 143.

In one or more embodiments, the display panel includes a plurality of active switches, the active switches 140 are disposed on the first underlay substrate 100, and the active switch includes a gate 143, a semiconductor 145, a source 141 and a drain 142 disposed in sequence, one side of the first chemically resistive layer is in contact with the first surface of the color filter; and an other side of the first chemically resistive layer is in contact with the source and the drain.

The conducting layer is made of indium tin oxides. The indium tin oxides not only have good electrical conductivity, but also good light transmission. It should be explained that the conducting layer in the embodiment of the present application is not limited thereto. Other transparent conducting layers can also be adopted.

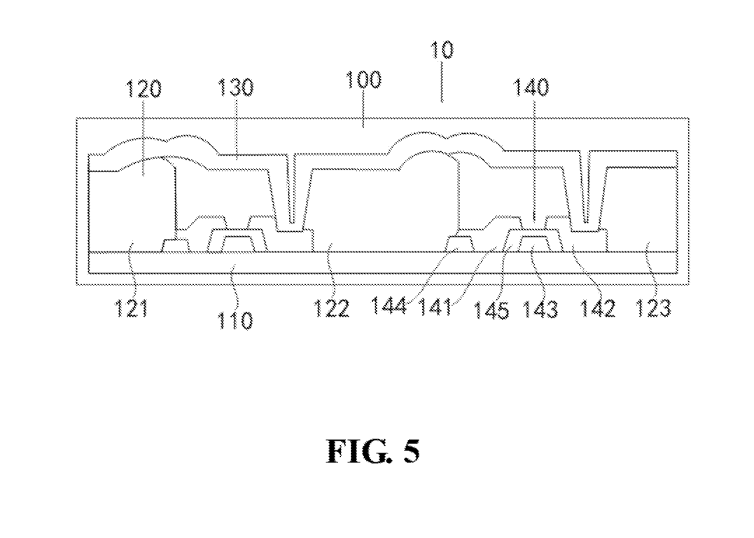

As shown in FIG. 5, FIG. 5 is a structural schematic diagram of a display apparatus in an embodiment of the present application. The present application further discloses a display apparatus 10 which includes the display panel 100. The display apparatus 10 may be a liquid crystal display apparatus or an OLED display apparatus. When the display apparatus 10 in the embodiment of the present application is the liquid crystal display apparatus, the liquid crystal display apparatus includes a backlight module. The backlight module may be used as a light source used for supplying sufficient brightness and uniformly distributed light sources. The backlight module in the present embodiment may be a front-light type, or a backlight type. It should be noted that the backlight module in the present embodiment is not limited thereto. The display panel 100 in the display apparatus in the present embodiment is just a specific structure of the present embodiment. See the above embodiments and FIG. 1 for details. However, it should be explained that the structure of the display panel 100 in the display apparatus of the present embodiment is not limited thereto. Also see the above embodiments and FIG. 2 to FIG. 4. The display panel is not described herein in detail.

The above contents are further detailed descriptions of the present application in combination with specific preferred embodiments. However, the concrete implementation of the present application shall not be considered to be only limited to these descriptions. For those of ordinary skill in the art to which the present application belongs, several simple deductions or replacements may be made without departing from the conception of the present application, all of which shall be considered to belong to the protection scope of the present application.

What is claimed is:

1. A display panel, comprising;
a first underlay substrate;
a color filter layer, made of a chemically resistive material, wherein the color filter layer comprises a first surface and a second surface opposite to the first surface, the color filter layer is disposed on the first underlay substrate, and the first surface of the color filter layer is disposed towards to the first underlay substrate;
a conducting layer, disposed on the color filter layer; and
a plurality of active switches, disposed on the first underlay substrate;
wherein the first surface of the color filter layer is in contact with the first underlay substrate, and the second surface of the color filter layer is in contact with the conducting layer;
the active switch comprises a gate, a semiconductor, a source and a drain disposed in sequence; the source and the drain are in contact with the first surface of the color filter, and the color filter is doped with inorganic material.

2. A display panel, comprising:
a first underlay substrate;
a color filter layer, made of chemically resistive material, wherein the color filter layer comprises a first surface and a second surface opposite to the first surface, the color filter layer is disposed on the first underlay substrate, and the first surface of the color filter layer is disposed towards to the first underlay substrate, and
a conducting layer, disposed on the color filter layer, and the second surface of the color filter layer is disposed towards to the conducting layer.

3. The display panel according to claim 2, wherein the first surface of the color filter layer is in contact with the first underlay substrate, and the second surface of the color filter layer is in contact with the conducting layer.

4. The display panel according to claim 2, wherein the display panel comprises a first chemically resistive layer, and the first chemically resistive layer is disposed between the first surface of the color filter and the first underlay substrate.

5. The display panel according to claim 4, wherein the first chemically resistive layer is made of an inorganic insulating film.

6. The display panel according to claim 4, wherein the display panel comprises a plurality of active switches, the active switches are disposed on the first underlay substrate, and the active switch comprises a gate, a semiconductor, a source and a drain disposed in sequence;
one side of the first chemically resistive layer is in contact with the first surface of the color filter, and the other side of the first chemically resistive layer is in contact with the source and the drain.

7. The display panel according to claim 2, wherein the display panel comprises a second chemically resistive layer, and the second chemically resistive layer is disposed between the second surface of the color filter and the conducting layer.

8. The display panel according to claim 7, wherein the second chemically resistive layer is made of an inorganic insulating film.

10. The display panel according to claim 7, wherein the second chemically resistive layer is made of an organic insulating film.

11. The display panel according to claim 2, wherein a plurality of active switches are disposed on the first underlay substrate.

12. The display panel according to claim 3, wherein the display panel comprises a plurality of active switches, the active switches are disposed on the first underlay substrate, and the active switch comprises a gate, a semiconductor, a source and a drain disposed in sequence;
one side of the first chemically resistive layer is in contact with the first surface of the color filter, and the other side of the first chemically resistive layer is in contact with the source and the drain.

13. The display panel according to claim 2, wherein the color filter layer is made of chemically resistive material, the chemically resistive material comprises inorganic material.

14. The display panel according to claim 2, wherein the display panel comprises:
a first chemically resistive layer, disposed between the first surface of the color filter and the first underlay substrate, and the first chemically resistive layer is made of an inorganic insulating film,
a plurality of active switches, disposed on the first underlay substrate; and
a second chemically resistive layer, disposed on the second surface of the color filter layer,
wherein the second chemically resistive layer is disposed between the second surface of the color filter and the conducting layer, the second chemically resistive layer is made of an inorganic insulating film or an organic insulating film; and the conducting layer is made of indium tin oxides.

15. A display apparatus, comprises a backlight module and a display panel, wherein the display panel comprising:
a first underlay substrate:
a color filter layer, made of chemically resistive material, wherein the color filter layer comprises a first surface and a second surface opposite to the first surface, the color filter layer is disposed on the first underlay substrate, and the first surface of the color filter layer is disposed towards to the first underlay substrate, and
a conducting layer, disposed on the color filter layer, and the second surface of the color filter layer is disposed towards to the conducting layer.

16. The display apparatus according to claim 15, wherein the first surface of the color filter layer is in contact with the first underlay substrate, and the second surface of the color filter layer is in contact with the conducting layer, and a plurality of active switches are disposed on the first underlay substrate, and the conducting layer is made of indium tin oxides.

17. The display apparatus according to claim 16, wherein the active switch comprises a gate, a semiconductor, a source and a drain disposed in sequence:
one side of the first chemically resistive layer is in contact with the first surface of the color filter, and the other side of the first chemically resistive layer is in contact with the source and the drain.

18. The display apparatus according to claim 15, wherein the display panel comprises a first chemically resistive layer, and the first chemically resistive layer is disposed between the first surface of the color filter and the first underlay substrate, and the first chemically resistive layer is made of an inorganic insulating film, and a plurality of active switches are disposed on the first underlay substrate, and the conducting layer is made of indium tin oxides.

19. The display apparatus according to claim 18, wherein the active switch comprises a gate, a semiconductor, a source and a drain are disposed in sequence;
one side of the first chemically resistive layer is in contact with the first surface of the color filter, and the other side of the first chemically resistive layer is in contact with the source and the drain.

20. The display apparatus according to claim 15, wherein the display panel comprises a second chemically resistive layer, and the second chemically resistive layer is disposed between the second surface of the color filter and the conducting layer; the second chemically resistive layer is made of an inorganic insulating film or an organic insulating film; and a plurality of active switches are disposed on the first underlay substrate, and the conducting layer is made of indium tin oxides.
